(19) United States
(12) Patent Application Publication
(10) Pub. No.: US 2026/0312493 A1
(43) Pub. Date: Oct. 8, 2026

(54) RESONANT CHARGE PUMP CIRCUIT

(71) Applicant: Qorvo US, Inc., Greensboro, NC (US)

(72) Inventor: Masashi Nogawa, Sachse, TX (US)

(21) Appl. No.: 19/343,055

(22) Filed: Sep. 29, 2025

Related U.S. Application Data
(60) Provisional application No. 63/734,226, filed on Dec. 16, 2024.

(51) Int. Cl. H02M 3/07; H02M 1/38; H02M 3/158

(52) U.S. Cl. CPC H02M 3/07; H02M 1/385; H02M 3/158

(57) ABSTRACT

A resonant charge pump circuit includes a resonant circuit having a bucket capacitor and a bucket inductor connected in series, and a switching circuit connected to the resonant circuit. The switching circuit switches to a first state that enables current to flow from an input terminal into the resonant circuit to charge the bucket capacitor and the bucket inductor, and switches to a second state that enables current to flow from the resonant circuit to discharge the bucket capacitor and the bucket inductor to an output terminal. The resonant circuit controls current flow into and out from the resonant circuit when the switching circuit switches between the states. The resonant charge pump circuit also includes a timing circuit that controls when the switching circuit switches between the states.

### CROSS-REFERENCE TO RELATED APPLICATIONS

This application claims the benefit of provisional patent application Ser. No. 63/734,226, filed Dec. 16, 2024, the disclosure of which is hereby incorporated herein by reference in its entirety.

### TECHNICAL FIELD

The present invention relates generally to charge pumps, and in particular, to a high-power and high-efficiency resonant charge pump.

### BACKGROUND INFORMATION

A very common requirement in electronic circuits is to convert an available direct circuit (DC) voltage source to a lower or higher DC voltage. One way to do this is by using a charge pump circuit. The charge pump uses a capacitor as an energy-storage element. During operation, current (charge) is alternately switched and directed between two capacitors arranged so that the circuit output is twice the input, and thus functioning as a voltage-doubling boost converter. In other configurations, the charge pump acts as a voltage “divider” in half or step-down converters.

Unfortunately, a traditional charge pump circuit may not be suitable for high power applications, even though it is known to have fairly good conversion efficiency. For example, during the charge pump's switching operation, a large amount of current flows through the components in a very short time period. This is referred to as inrush current and has the potential to damage circuit elements (e.g., fusing devices or placing high stress on devices).

Therefore, it is desirable to have a high-efficiency charge pump circuit that is suitable for high power applications and that overcomes the problems associated with conventional circuits.

### SUMMARY

In various embodiments, a high-power and high-efficiency resonant charge pump circuit is provided. The resonant charge pump overcomes the problems associated with large inrush currents experienced by conventional circuits. Therefore, embodiments of the resonant charge pump are suitable for applications where high-power and high-efficiency is desired. As an added benefit, the resonant charge pump operates with very low electromagnetic interference (EMI).

Embodiment 1. A resonant charge pump circuit, including: a resonant circuit having a bucket capacitor and a bucket inductor connected in series; a first transistor configured to be turned off and turned on, the first transistor being connected to enable current to flow from an input terminal into the resonant circuit to charge the bucket capacitor and the bucket inductor when the first transistor is turned on and to disable the current to flow from the input terminal into the resonant circuit when the first transistor is turned off; a second transistor configured to be turned off and turned on, the second transistor being configured to enable the current to flow from the resonant circuit to discharge the bucket capacitor and the bucket inductor to an output terminal when the second transistor is turned on and to disable the current to flow from the resonant circuit to the output terminal when the second transistor is turned off; and a synchronization circuit configured to generate a clock signal such that the turning off and turning on of the first transistor and the second transistor is synchronized in accordance with the clock signal, wherein the synchronization circuit is configured to detect an activation of a first body diode of the first transistor and an activation of a second body diode of the second transistor and adjust a frequency of the clock signal in response to either the activation of the first body diode or the activation of the second body diode.

Embodiment 2. The resonant charge pump circuit of embodiment 1, wherein: the first transistor is a first field effect transistor (FET); and the second transistor is a second FET.

Embodiment 3. The resonant charge pump circuit of embodiment 1, wherein the synchronization circuit is configured to: increase the frequency of the clock signal in response to detecting the activation of the first body diode; and decrease the frequency of the clock signal in response to detecting the activation of the second body diode.

Embodiment 4. The resonant charge pump circuit of embodiment 1, wherein the synchronization circuit is configured to: decrease the frequency of the clock signal in response to detecting the activation of the first body diode; and increase the frequency of the clock signal in response to detecting the activation of the second body diode.

Embodiment 5. The resonant charge pump circuit of embodiment 1, wherein the synchronization circuit is configured to operate the turning on and turning off of the first transistor and the second transistor in accordance with the clock signal such that: the first transistor is turned on and the second transistor is turned off in a first state; the second transistor is turned on and the first transistor is turned off in a second state; and both the first transistor and the second transistor are turned off in a third state.

Embodiment 6. The resonant charge pump circuit of embodiment 5, wherein the synchronization circuit is configured to detect the activation of the first body diode of the first transistor and the activation of the second body diode of the second transistor when both the first transistor and the second transistor are turned off in the third state.

Embodiment 7. The resonant charge pump circuit of embodiment 6, wherein the synchronization circuit includes: a comparator that receives an intermediary voltage from an intermediary node that is between the first transistor and the second transistor, the comparator being configured to generate a detection signal in a detection state in response to the intermediary voltage being above a threshold voltage level that is above an input voltage level of an input voltage at the input terminal; an AND gate that is configured to receive a deadtime signal that is in a deadtime state in response to the third state, the AND gate being configured to generate a frequency adjustment signal in a frequency adjustment state in response to the detection signal being in the detection state and the deadtime signal being in the deadtime state; and a one shot configured to adjust a clock frequency in response to the frequency adjustment signal being in the frequency adjustment state.

Embodiment 8. The resonant charge pump circuit of embodiment 6, wherein the synchronization circuit includes: a comparator that receives an intermediary voltage from an intermediary node that is between the first transistor and the second transistor, the comparator being configured to generate a detection signal in a detection state in response to the intermediary voltage being below a threshold voltage level that is below ground; an AND gate that is configured to receive a deadtime signal that is in a deadtime state in response to the third state, the AND gate being configured to generate a frequency adjustment signal in a frequency adjustment state in response to the detection signal being in the detection state and the deadtime signal being in the deadtime state; and a one shot configured to adjust a clock frequency in response to the frequency adjustment signal being in the frequency adjustment state.

Embodiment 9. The resonant charge pump circuit of embodiment 1, further including a switching circuit connected to the resonant circuit, wherein the switching circuit is configured to: switch to a first state that enables current to flow from the input terminal into the resonant circuit to charge the bucket capacitor and the bucket inductor; switch to a second state that enables the current to flow from the resonant circuit to discharge the bucket capacitor and the bucket inductor to the output terminal; and switch to a third state that disables the current from flowing from the input terminal into the resonant circuit and that disables the current to flow from the resonant circuit to discharge the bucket capacitor and the bucket inductor to the output terminal.

Embodiment 10. The resonant charge pump circuit of embodiment 9, wherein the switching circuit includes the first transistor and the second transistor.

Embodiment 11. The resonant charge pump circuit of embodiment 9, wherein: the first transistor connects the input terminal to the resonant circuit when the switching circuit is in the first state and disconnects the input terminal from the resonant circuit when the switching circuit is in the second state and in the third state, the first transistor being external to the switching circuit; and the second transistor connects the resonant circuit to the output terminal when the switching circuit is in the second state and disconnects the output terminal from the resonant circuit when the switching circuit is in the first state and in the third state, the second transistor being external to the switching circuit.

Embodiment 12. A method for operating a resonant charge pump, the method including: in a first state, turning on a first transistor to enable current to flow from an input terminal into a resonant circuit to charge a bucket capacitor and a bucket inductor and turning off a second transistor to disable current to flow from the resonant circuit to discharge the bucket capacitor and the bucket inductor to an output terminal; in a second state, turning off the first transistor to disable the current from flowing from the input terminal into the resonant circuit to charge the bucket capacitor and turning off the second transistor to disable the current from flowing from the resonant circuit to discharge the bucket capacitor and the bucket inductor to the output terminal; in a third state, turning off the first transistor to disable the current from flowing from the input terminal into the resonant circuit to charge the bucket capacitor and the bucket inductor and turning on the second transistor to enable the current to flow from the resonant circuit to discharge the bucket capacitor and the bucket inductor to the output terminal; generating a clock signal such that the opening and closing of the first transistor and the second transistor is synchronized in accordance with the clock signal; detecting that any one of either an activation of a first body diode of the first transistor is activated or an activation of a second body diode of the second transistor is in the second state; and adjusting a frequency of the clock signal in response to either the activation of the first body diode or the activation of the second body diode.

Embodiment 13. The method of embodiment 12, wherein adjusting the frequency of the clock signal in response to either the activation of the first body diode or the activation of the second body diode includes: increasing the frequency of the clock signal in response to detecting the activation of the first body diode; and decreasing the frequency of the clock signal in response to detecting the activation of the second body diode.

Embodiment 14. The method of embodiment 12, wherein adjusting the frequency of the clock signal in response to either the activation of the first body diode or the activation of the second body diode includes: decreasing the frequency of the clock signal in response to detecting the activation of the first body diode; and increasing the frequency of the clock signal in response to detecting the activation of the second body diode.

Embodiment 15. The method of embodiment 12, wherein detecting that any one of either the activation of the first body diode of the first transistor is activated or the activation of the second body diode of the second transistor is in the second state includes: receiving an intermediary voltage from an intermediary node that is between the first transistor and the second transistor; generating a detection signal in a detection state in response to the intermediary voltage being above a threshold voltage level that is above an input voltage level of an input voltage at the input terminal; and receiving a deadtime signal that is in a deadtime state in response to the second state.

Embodiment 16. The method of embodiment 15, wherein adjusting the frequency of the clock signal in response to either the activation of the first body diode or the activation of the second body diode includes: generating a frequency adjustment signal in a frequency adjustment state in response to the detection signal being in the detection state and the deadtime signal being in the deadtime state; and adjusting a clock frequency in response to the frequency adjustment signal being in the frequency adjustment state.

Embodiment 17. The method of embodiment 12, wherein detecting that any one of either the activation of the first body diode of the first transistor is activated or the activation of the second body diode of the second transistor is in the second state includes: receiving an intermediary voltage from an intermediary node that is between the first transistor and the second transistor; generating a detection signal in a detection state in response to the intermediary voltage being below a threshold voltage level that is below ground; and receiving a deadtime signal that is in a deadtime state in response to the second state.

Embodiment 18. The method of embodiment 17, wherein adjusting the frequency of the clock signal in response to either the activation of the first body diode or the activation of the second body diode includes: generating a frequency adjustment signal in a frequency adjustment state in response to the detection signal being in the detection state and the deadtime signal being in the deadtime state; and adjusting a clock frequency in response to the frequency adjustment signal being in the frequency adjustment state.

Embodiment 19. A power system including a resonant charge pump circuit, the resonant charge pump circuit including: a resonant circuit having a bucket capacitor and a bucket inductor connected in series; a first transistor configured to be turned off and turned on, the first transistor being connected to enable current to flow from an input terminal into the resonant circuit to charge the bucket capacitor and the bucket inductor when the first transistor is turned on and to disable the current to flow from the input terminal into the resonant circuit to charge the bucket capacitor and the bucket inductor when the first transistor is turned off; a second transistor configured to be turned off and turned on, the second transistor being configured to enable the current to flow from the resonant circuit to discharge the bucket capacitor and the bucket inductor to an output terminal when the second transistor is turned on and to disable the current to flow from the resonant circuit to discharge the bucket capacitor and the bucket inductor to the output terminal when the second transistor is turned off; and a synchronization circuit configured to generate a clock signal such that the opening and closing of the first transistor and the second transistor is synchronized in accordance with the clock signal, wherein the synchronization circuit is configured to detect an activation of a first body diode of the first transistor and an activation of a second body diode of the second transistor and adjust a frequency of the clock signal in response to either the activation of the first body diode or the activation of the second body diode.

Embodiment 20. The power system of embodiment 19, wherein the synchronization circuit is configured to: increase the frequency of the clock signal in response to detecting the activation of the first body diode; and decrease the frequency of the clock signal in response to detecting the activation of the second body diode.

Embodiment 21. The power system of embodiment 19, wherein the synchronization circuit is configured to: decrease the frequency of the clock signal in response to detecting the activation of the first body diode; and increase the frequency of the clock signal in response to detecting the activation of the second body diode.

Further details and embodiments are described in the Detailed Description below. This Summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1A shows an embodiment of a charge pump circuit.

FIG. 1B shows an embodiment of a charge pump circuit.

FIG. 2A shows diagrams that illustrate current flow through the charge pump circuit shown in FIG. 1A.

FIG. 2B shows an alternate embodiment of the charge pump circuit shown in FIG. 1A that reduces inrush currents.

FIG. 2C shows diagrams that illustrate the operation of the charge pump circuit shown in FIG. 1A with an addition of a resistor.

FIG. 3A shows an embodiment of a resonant charge pump circuit.

FIG. 3B shows an embodiment of a resonant charge pump circuit.

FIG. 4 shows an embodiment of a resonant charge pump circuit that simulates the operation of the resonant charge pump circuit shown in FIG. 3A.

FIG. 5 shows graphs that illustrate voltage and current waveforms associated with synchronized operation of the resonant charge pump circuit shown in FIG. 4.

FIG. 6 shows graphs that illustrate voltage and current waveforms associated with unsynchronized operation of the resonant charge pump circuit shown in FIG. 4.

FIG. 7 shows an embodiment of a resonant charge pump circuit that includes a synchronization circuit.

FIG. 8 shows an embodiment of a resonant charge pump circuit with synchronization.

FIG. 9 shows graphs that illustrate voltage and current waveforms associated with the resonant charge pump circuit shown in FIG. 8.

FIG. 10 shows another embodiment of a resonant charge pump circuit that simulates the operation of the resonant charge pump circuit shown in FIG. 3A.

FIG. 11 shows an example of an intermediary node voltage.

FIG. 12 shows a synchronization circuit.

### DETAILED DESCRIPTION

Reference will now be made in detail to some exemplary embodiments of the invention, examples of which are illustrated in the accompanying drawings.

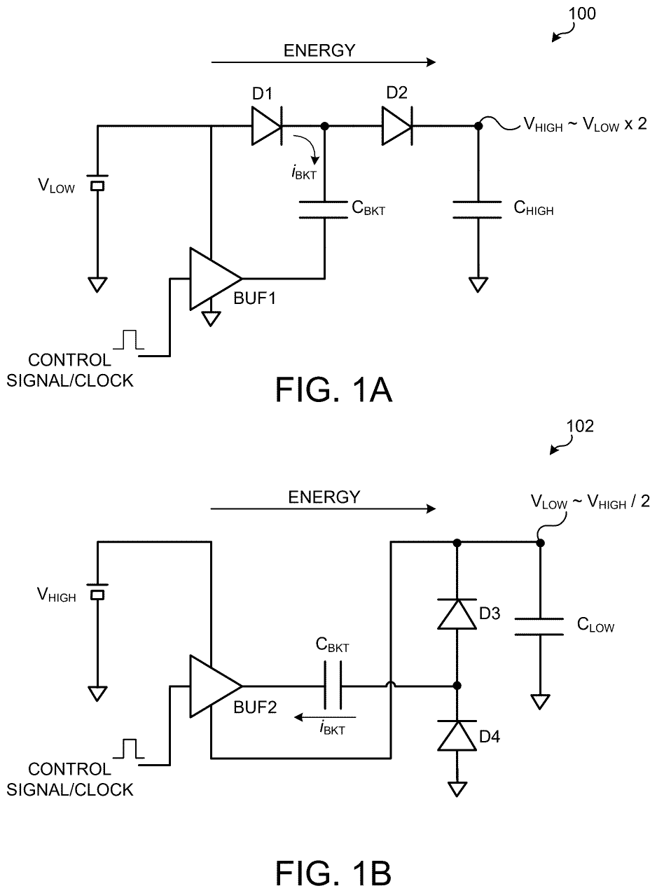

FIG. 1A shows an embodiment of a charge pump circuit 100. The charge pump circuit 100 converts a low voltage (V_{LOW}) to a higher voltage (V_{HIGH}) where V_{HIGH}=V_{LOW}×2. A buffer (BUF1) receives a clock signal that causes the buffer output to switch between a first level at V_{LOW} and a second level at ground. When BUF1 output is at ground, a bucket current i_{BKT} flows into a bucket capacitor (C_{BKT}) and charges C_{BKT} up to the level of V_{LOW}. When the output of BUF1 switches to V_{LOW}, the voltage of C_{BKT} is added to BUF1 output such that the voltage level at the output of a diode D2 is equal to (2×V_{LOW}). Thus, the charge pump circuit 100 acts as a voltage doubler.

FIG. 1B shows an embodiment of a charge pump circuit 102. The charge pump circuit 102 converts V_{HIGH} to V_{LOW} where V_{LOW}=V_{HIGH}/2. The charge pump circuit 102 performs in a similar manner to the charge pump circuit 100 shown in FIG. 1A but operates to reduce the t voltage V_{HIGH} to the output voltage V_{LOW}. Thus, the charge pump circuit 102 acts as a voltage divider or step-down charge pump. The two charge pump circuits 100, 102 are symmetrical and have similar disadvantages when used in high power applications. For example, the two charge pump circuits 100, 102 experience large inrush currents when BUF1 switches state. These large inrush currents can damage circuit components. This issue is illustrated in greater detail below.

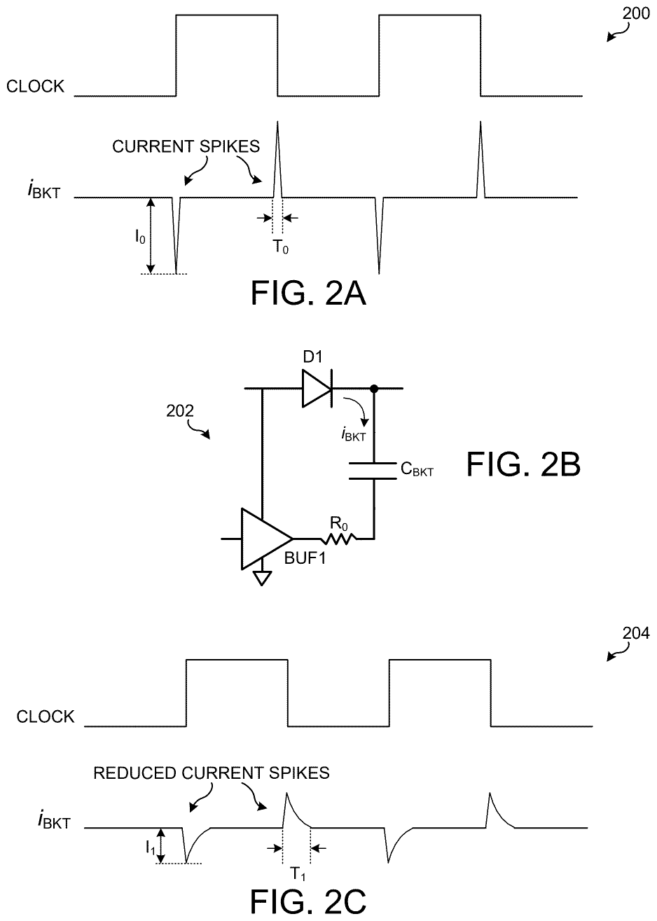

FIG. 2A show diagrams 200 that illustrate current flow through the charge pump circuit 100 shown in FIG. 1A. The diagrams 200 show the clock signal and the bucket current i_{BKT}. As can be seen from the diagrams 200, when the clock signal switches state, the bucket current i_{BKT} experiences a large current spike. These current spikes have very large amplitude (I₀) and occur over a very short time duration (T₀). In high power applications, these current spikes can become very large. If the charge pump circuit 100 is used in high power applications, an additional circuit would be needed to avoid the huge inrush currents, otherwise the inrush currents could damage circuit elements (fusing devices or placing high stress on devices) that may shorten product life. Thus, it is desirable to have a way to control or reduce the inrush current spikes.

FIG. 2B shows an alternate embodiment of the charge pump circuit 100 shown in FIG. 1A that reduces inrush currents. For example, a resistor is added to the charge pump circuit 100 to control or reduce inrush current spikes. For example, a circuit 202 illustrates how a resistor R₀ is added to the output of BUF1. The resistor R₀ reduces the inrush current since the inrush current through the resistor R₀ generates a voltage drop that reduces the voltage across C_{BKT}. However, use of the resistor R₀ also reduces conversion efficiency.

FIG. 2C shows diagrams 204 that illustrate the operation of the circuit 100 shown in FIG. 1A with the addition of the resistor R₀. The diagrams 204 show the clock signal and the bucket current i_{BKT}. As can be seen from the diagrams 204, when the clock signal switches state, the bucket current i_{BKT} experiences a reduced current spike. For example, the current spikes have an amplitude (I₁) that is smaller than I₀ and less likely to damage circuit components. These smaller spikes occur over a time duration (T₁) that has a time-constant based on the resistor R₀ and C_{BKT}, which is longer than T₀. Thus, with the addition of the resistor R₀, it is possible to use the charge pump circuit 100 in high voltage applications. However, it should be noted that the resistor R₀ also reduces conversion efficiency of the charge pump circuit 100. Therefore, it is desirable to have a way to control or reduce current spikes without affecting the efficiency of the charge pump circuit 100.

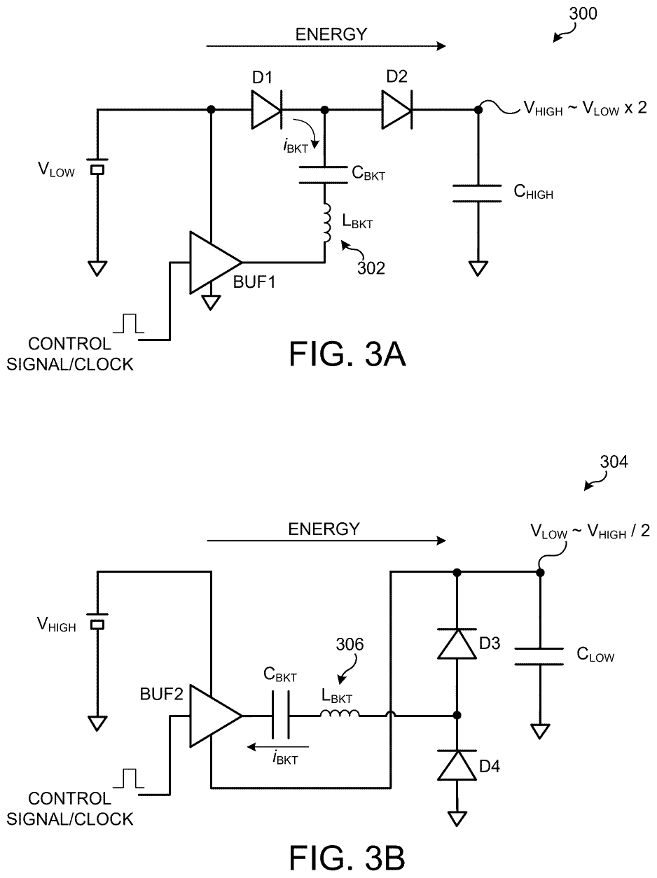

FIG. 3A shows an embodiment of a resonant charge pump circuit 300. The resonant charge pump circuit 300 converts V_{LOW} to V_{HIGH} where V_{HIGH}=V_{LOW}×2. The resonant charge pump circuit 300 is similar to the charge pump circuit 100 shown in FIG. 1A except that an inductor (or coil) L_{BKT} 302 has been added at the output of BUF1. The inductor L_{BKT} 302 combines with C_{BKT} to form a resonant circuit that operates to control or reduce the current spikes. In exemplary embodiments, an LC resonant circuit produces current flow that is sinusoidal in shape, and therefore, the inrush current problem is solved. Since the resonant circuit has no resistance or power loss, it is suitable to control or reduce the current spikes in charge pump circuits even in high power applications.

FIG. 3B shows an embodiment of a resonant charge pump circuit 304. The resonant charge pump circuit 304 converts V_{HIGH} to V_{LOW} where V_{LOW}=V_{HIGH}/2. The resonant charge pump circuit 304 is similar to the charge pump circuit 102 shown in FIG. 1B except that an inductor (or coil) L_{BKT} 306 has been added at the output of a buffer (BUF2). It should be noted that, although the inductor L_{BKT} 306 is located on the opposite side of C_{BKT}, the effects of the resonant circuit are the same as in the resonant charge pump circuit 300.

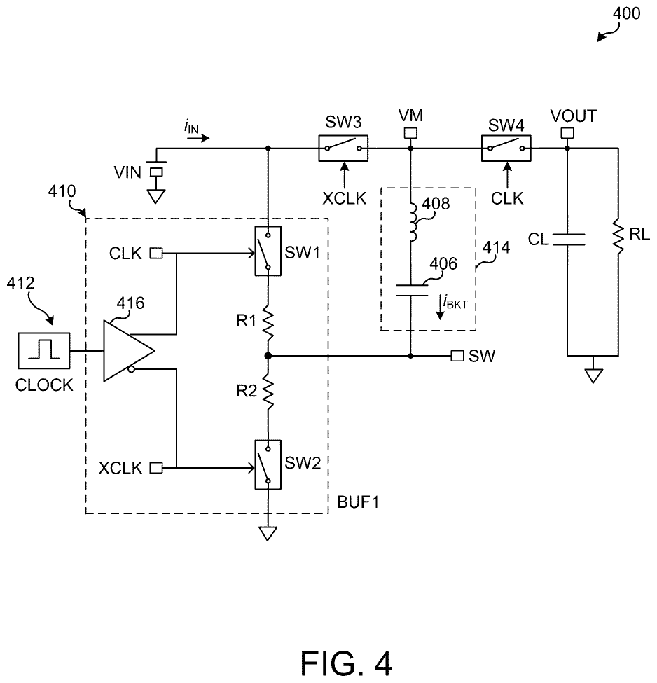

FIG. 4 shows an embodiment of a resonant charge pump circuit 400 that simulates the operation of the resonant charge pump circuit 300 shown in FIG. 3A. With the goal of high power applications in mind, the resonant charge pump circuit 400 includes transistors SW3, SW4 that replace a diode D1 and the diode D2. The resonant charge pump circuit 400 also includes a switching circuit 410 that comprises a buffer 416; transistors switches SW1, SW2; and resistors R1, R2. The resonant charge pump circuit 400 also includes an output load capacitor CL and a resistor RL.

The transistors SW3, SW4 are synchronized to a control clock signal 412. The resonant charge pump circuit 400 also includes a bucket capacitor (C_{BKT}) 406 and a bucket inductor (L_{BKT}) 408 that form an LC resonant circuit 414 that maintains its self-oscillation for a long time period (ideally, forever oscillation) until parasitic resistance converts resonant energy into heat. The switching circuit 410 functions as BUF1 to receive the control clock signal 412 and generate an output (SW) that switches state between V_{LOW} and ground in response to the control clock signal 412.

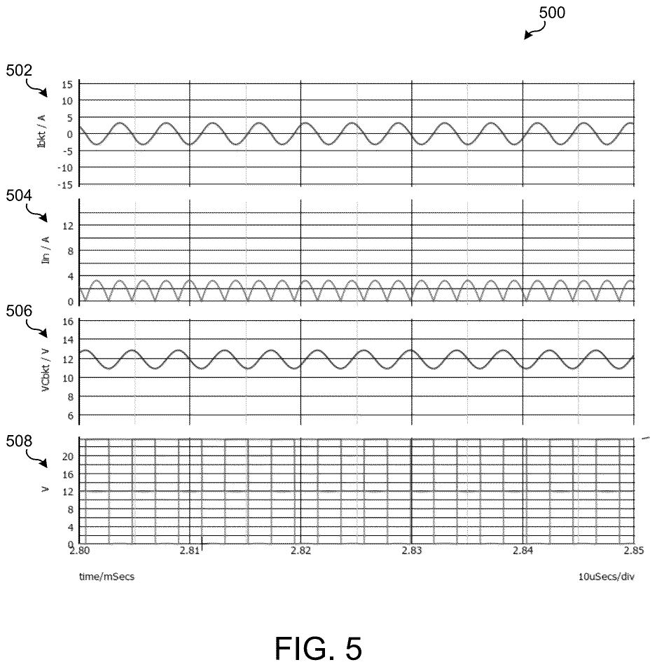

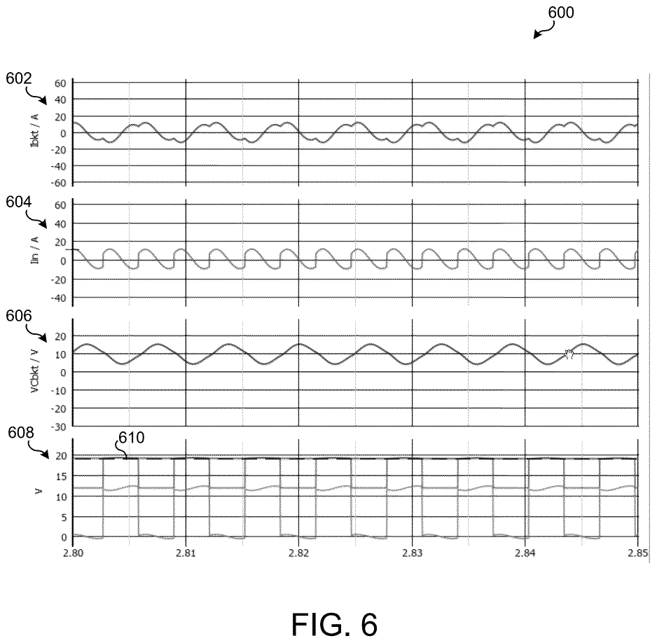

The LC resonant circuit 414 delivers the energy back and forth to a node VM. To maintain the direction of energy delivery, the timing of the switching needs to be synchronized to the LC resonant frequency. As a result, the resonant charge pump circuit 400 receives a low input voltage (VIN) (e.g., 12 volts) and generates a high output voltage (VOUT) that is approximately twice VIN (2×VIN). The operations of the resonant charge pump circuit 400, both synchronized and unsynchronized, are shown in FIGS. 5 and 6, respectively.

FIG. 5 shows graphs 500 that illustrate voltage and current waveforms associated with synchronized operation of the resonant charge pump circuit 400 shown in FIG. 4. For example, the graphs 500 include a graph 502 showing the bucket current i_{BKT}, a graph 504 showing an input current (iin), a graph 506 showing the voltage across the bucket capacitor C_{BKT} 406, and a graph 508 showing VOUT. As illustrated in the graph 502, the resonant circuit (the bucket capacitor C_{BKT} 406, the bucket inductor L_{BKT} 408) has eliminated large current spikes on the bucket current i_{BKT}. For example, the graph 502 shows a perfectly sinusoidal example of the bucket current i_{BKT} waveform. Thus, the resonant circuit suppresses current spikes when BUF1 (switching circuit) switches between the first and second states. It should be noted also that the graph 508 of the output voltage shows that the output voltage (e.g., 24 volts) remains constant at (2×V_{LOW}). These results show that the synchronized resonant circuit reduces or eliminates large inrush current, thereby allowing the resonant charge pump circuit 400 to be used in high power applications.

FIG. 6 shows graphs 600 that illustrate voltage and current waveforms associated with unsynchronized operation of the resonant charge pump circuit 400 shown in FIG. 4. For example, graphs 600 include a graph 602 showing the bucket current i_{BKT}, a graph 604 showing iin, a graph 606 showing voltage across the bucket capacitor C_{BKT} 406, and a graph 608 showing VOUT. As can be seen from the graph 608, the output “dashed line” 610 is below 20V (and not 24 volts) because of the unsynchronized energy delivery of the LC circuit. Thus, it is desirable to have a way to maintain synchronization of the resonant charge pump circuit 400 to obtain proper operation, as illustrated in FIG. 5.

### Resonant Charge Pump Synchronization

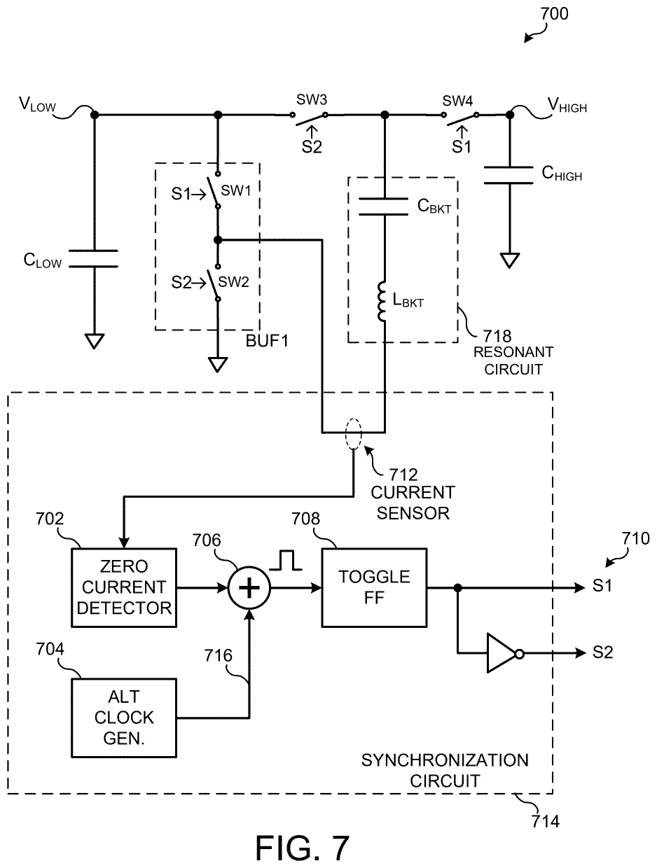

FIG. 7 shows an embodiment of a resonant charge pump circuit 700 that includes a synchronization circuit 714. In one embodiment, a current sensor 712 senses current on the output of BUF1. The sensed current is input to a zero-current detector 702 that detects zero-current events on the output of BUF1. Detection pulses associated with the detected zero-current events are input to an “OR” device 706 that also receives a clock signal from an alternate clock generator 704 (discussed in greater detail below). During normal operation, the detection pulses output from the zero-current detector 702 flow through the OR device 706 and are input to a toggle flip flop (FF) 708. The output of the toggle FF 708 is used to generate complementary synchronized clock signals S1, S2 that drive the transistor switches SW1, SW2 and the transistors SW3, SW4 of the resonant charge pump circuit 700. In another mode of operation, if the zero-current detector 702 fails to detect zero-current events, the alternate clock generator 704 generates an alternate clock 716 that passes through the OR device 706 to the input of the toggle FF 708. Thus, in the case of low current through the LC circuit such that no zero-current events are detected, the alternate clock generator 704 generates the clock signals used by the resonant charge pump circuit 700. In one embodiment, the synchronization circuit 714 is implemented on an integrated circuit.

During operation of the resonant charge pump circuit 700, the direction of energy delivery is maintained by detecting the zero-current flow timing of an LC resonant circuit 718. In one embodiment, when zero-current events of the LC resonant circuit 718 are detected, the complementary synchronized clock signals S1, S2 change state from high-to-low or low-to-high. Appropriately changing the state of the complementary synchronized clock signals S1, S2 results in current flow in one direction.

### Alternate Clock Generator

When a load of the resonant charge pump circuit 700 becomes very small, it may become difficult for the zero-current detector 702 to detect “zero-current” events because current delivered by the LC resonant circuit 718 may fall below the detection threshold. In this case, the alternate clock generator 704 operates to keep the circuit pumping. In one embodiment, a simple logic timing circuit can be used to generate the alternate clock 716. When no detection pulses are output from the zero-current detector 702, the alternate clock generator 704 starts its timer and maintains periodic flipping of the complementary synchronized clock signals S1/S2. In this condition, the load current is very small, and it is of little effect if the alternate clock timing is synchronized or not. It is preferable to set this alternate clock period almost equal to or slightly longer than the LC resonant design target.

In various embodiments, the “zero-current sense” circuit may have a certain limit on its detection range. This is a case of light to zero load current from the output side (either one of V_{LOW} or V_{HIGH}) depending on step-down or step-up pumping operation.

In a light-load condition, because of almost negligible current flow between the input and output sides, maintaining accurate LC resonant frequency timing on the complementary synchronized control clock signals S1, S2 is not required. It is desirable to supply approximate timing on the complementary synchronized clock signals S1, S2 to maintain the output voltage. Thus, the alternate clock generator 704 maintains clocking of the complementary synchronized clock signals S1, S2 while the zero-current sensing circuit is out of operation (sensing).

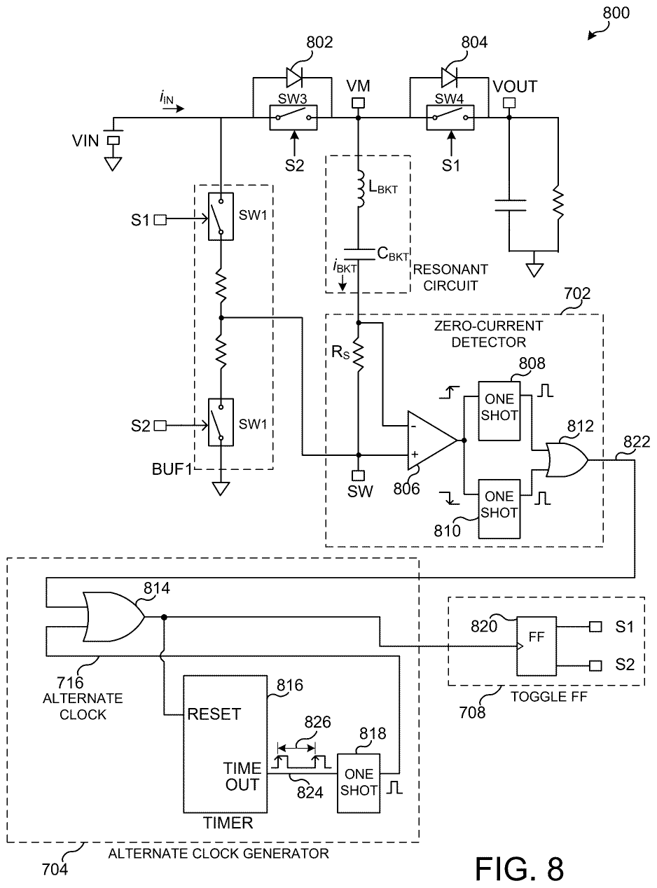

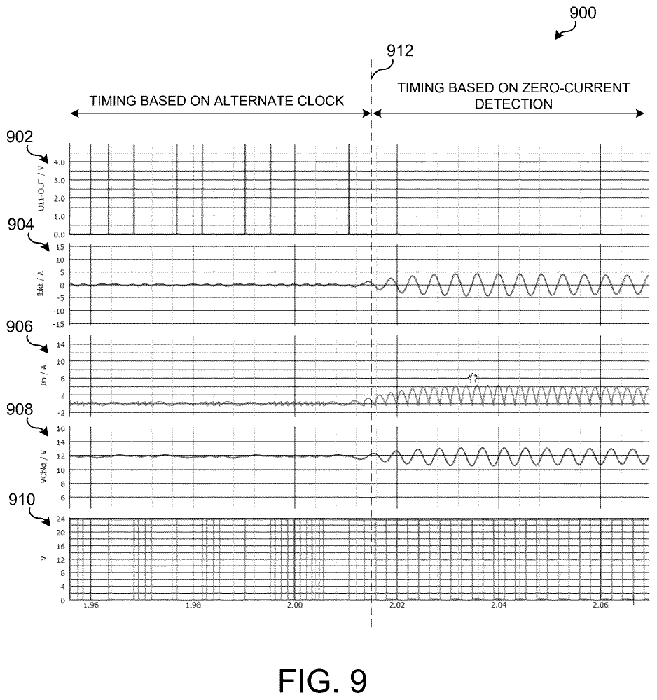

FIG. 8 shows an embodiment of a resonant charge pump circuit 800 with synchronization. In one embodiment, the resonant charge pump circuit 800 is an implementation of the resonant charge pump circuit 700 shown in FIG. 7. The resonant charge pump circuit 800 includes the zero-current detector 702, the alternate clock generator 704, and the toggle FF 708 of FIG. 7. The results of the operation of the resonant charge pump circuit 800 are shown in FIG. 9. In one embodiment, the zero-current detector 702, the alternate clock generator 704, and the toggle FF 708 are implemented on an integrated circuit.

As discussed above, if there is very small current into the LC circuit, the zero-current detector 702 may not detect zero-current events properly. In one embodiment, two diodes 802, 804 are inserted across the transistors SW3, SW4 that function as the diodes D1, D2 shown in FIG. 1A and FIG. 4. In one embodiment, it may be preferable to stop using the transistors SW3, SW4 when the alternate clock 716 of FIG. 7 is driving the complementary synchronized clock signals S1, S2. The diodes 802, 804 maintain the output voltage during this time. Since this is a light-load condition, there is no need to worry about power loss. The diodes 802, 804 can suppress unneeded LC resonant ringing during the light-load condition. In one embodiment, the diodes 802, 804 are body diodes that are part of field effect transistors (FETs) used as the transistors SW3, SW4.

As illustrated in FIG. 8, the zero-current detector 702 comprises a sense resistor Rs, a comparator 806, a rising edge triggered one shot 808, a negative edge triggered one shot 810, and an OR gate 812. During operation, zero-current events are detected as changing voltage across the sense resistor Rs that are input to the comparator 806. The comparator 806 responds by outputting either a rising edge or falling edge signal that triggers one of the one shots 808, 810 to output a pulse to the OR gate 812. The OR gate 812 passes this pulse as a trigger pulse 822 to the alternate clock generator 704.

As illustrated in FIG. 8, the alternate clock generator 704 comprises a timer circuit 816, a one shot circuit 818, and an OR gate 814. A timing period 826 of the timer circuit 816 is set to be longer than the expected LC resonant frequency (including coil and capacitor tolerance). As long as the zero-current detector 702 outputs the trigger pulse 822 when there is a current flow direction change (e.g., zero-current sensing), the timer circuit 816 will be reset and the timing of the complementary synchronized clock signals S1, S2 remains under the control of the zero-current detector 702.

When in a light-load condition, the zero-current detector 702 fails to detect zero-current events and stops sending the trigger pulse 822. At this point, the timer circuit 816 is allowed to complete its timing cycle (timer runs out) and initiates the trigger pulse 822 from the one shot circuit 818. The output of the one shot circuit 818 forms the alternate clock 716 that flows through the OR gate 814 to toggle an FF 820 and the complementary synchronized clock signals S1, S2 to maintain the charge pump output. The pulse output of the OR gate 814 also restarts the timer circuit 816 so that the cycle of the complementary synchronized clock signals S1, S2 is repeated. Since the timing period 826 provided by the timer circuit 816 is set to be longer than the main LC resonant timing, as soon as the resonant charge pump circuit 800 gets out from the light-load condition, the zero-current detector 702 takes over control of the timing of the complementary synchronized clock signals S1, S2.

FIG. 9 shows graphs 900 that illustrate voltage and current waveforms associated with the resonant charge pump circuit 800 shown in FIG. 8. For example, the graphs 900 include a graph 902 that shows the alternate clock 716 shown in FIG. 7, a graph 904 that shows the bucket current i_{BKT}, a graph 906 that shows iin, a graph 908 that shows voltage across C_{BKT}, and a graph 910 that shows VOUT of the resonant charge pump circuit 800.

As illustrated in the graph 902, the alternate clock 716 provides clock pulse signals when the load current is small, for example, as indicated by the input current shown in the graph 906. When the load current increases and zero-current events begin to occur (shown at a time indicator 912) the zero-current detector 702 and the LC resonant circuit 718 take over to generate synchronized clock signals. This can be seen by the clean sinusoid waveforms after the time indicator 912, which result from the zero-current events that are detected by the zero-current detector 702. It should be noted that regardless of whether the synchronized clocks generated by the zero-current detector 702 or multiple ones of the alternate clock 716 generated by the alternate clock generator 704 are utilized, the resonant charge pump circuit 800 continues to output a stable 24-volt output, as illustrated in the graph 910.

### Low EMI Circuit Operation

In various embodiments, the resonant charge pump circuit operates with very low noise. For example, during low load current conditions, the resonant charge pump is not synchronized and operates based on the alternate clock. Since the energy that flows is so low, the circuit emits low EMI. During synchronous operation of the resonant charge pump circuit, the circuit operates using zero-current-switching (ZCS). This operating mode is well known to provide very good noise performance because high power transistors are switching when no current is flowing. Generally, EMI noise power comes from sudden changes of current flow, but the resonant charge pump circuit utilizes ZCS, which results in low EMI.

### Resonant Charge Pump With Alternative Synchronization Circuit

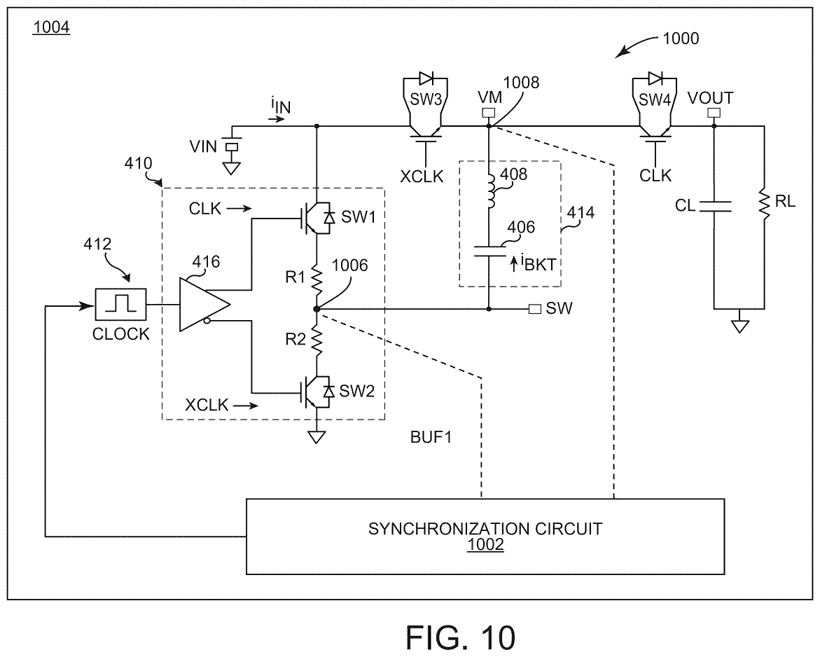

FIG. 10 shows another embodiment of a resonant charge pump circuit 1000 that simulates the operation of the resonant charge pump circuit 300 shown in FIG. 3A.

The resonant charge pump circuit 1000 is the same as the resonant charge pump circuit 400 shown in FIG. 4, except that the transistor switch SW1 is specifically a FET with a body diode, the transistor switch SW2 is specifically a FET with a body diode, the transistor SW3 is specifically a FET with a body diode, and the transistor SW4 is specifically a FET with a body diode. Furthermore, unlike the resonant charge pump circuit 400 shown in FIG. 4, the resonant charge pump circuit 1000 includes another embodiment of a synchronization circuit 1002. It should be noted that other embodiments of the resonant charge pump circuit 1000 may include multiple pairs of the transistor switches SW1, SW2 and multiple pairs of the transistors SW3, SW4 in parallel arrangements connected to the output terminal so that the output voltage can be charged to higher voltages by VIN.

In FIG. 10, the resonant charge pump circuit 1000 is included in a power circuit 1004. The improvement of the resonant charge pump circuit 1000 from the resonant charge pump circuit 400 shown in FIG. 4 is that the sense resistor Rs in the zero-current detector 702 of FIG. 8 is not used, so there is less resistance, which provides for higher conversion efficiency. In some embodiments, the transistor switches SW1, SW2 and the transistors SW3, SW4 may each be a Complementary Metal Oxide Semiconductor (CMOS) or a Bipolar CMOS (BiCMOS) silicon transistor or the transistor switches SW1, SW2 and the transistors SW3, SW4 may each be a Gallim Nitride (GaN) or a Silicon Carbide (SiC) transistor. The transistor switch SW2 is configured to be turned off (i.e., in a non-conducting state, open) and turned on (i.e., in a conducting state, closed). As explained above, the transistor switch SW2 is connected to enable current to flow from the input terminal into the LC resonant circuit 414 to charge the bucket capacitor C_{BKT} 406 and the bucket inductor L_{BKT} 408 when the transistor switch SW2 is turned on and to disable current to flow from an input terminal into the LC resonant circuit 414 when the transistor switch SW2 is turned off. The transistor switch SW1 is configured to be turned off and turned on. The transistor switch SW1 is configured to enable current to flow from the LC resonant circuit 414 to discharge the bucket capacitor C_{BKT} 406 and the bucket inductor L_{BKT} 408 to an output terminal when the transistor switch SW1 is turned on and to disable current to flow from the LC resonant circuit 414 to an output terminal when the transistor switch SW1 is turned off. The transistor switches SW1, SW2 are internal to the switching circuit 410. The transistor SW3 is also connected to enable current to flow from the input terminal into the LC resonant circuit 414 to charge the bucket capacitor C_{BKT} 406 and the bucket inductor L_{BKT} 408 when the transistor SW3 is turned on and to disable current to flow from an input terminal into the LC resonant circuit 414 when the transistor SW3 is turned off. The transistor SW4 is configured to be turned off and turned on. The transistor SW4 is configured to enable current to flow from the LC resonant circuit 414 to discharge the bucket capacitor C_{BKT} 406 and the bucket inductor L_{BKT} 408 to an output terminal when the transistor SW4 is turned on and to disable current to flow from the LC resonant circuit 414 to an output terminal when the transistor SW4 is turned off. The transistors SW3, SW4 are external to the switching circuit 410.

In this example, the transistor switch SW1 is connected between the input terminal and an intermediary node 1006. The intermediary node 1006 is connected to SW. The transistor switch SW2 is connected between the intermediary node 1006 and ground. The transistor SW3 is connected between the input terminal and an intermediary node 1008. The intermediary node 1008 is directly connected to the node VM. The transistor SW4 is connected between the intermediary node 1008 and the output terminal.

The synchronization circuit 1002 is configured to generate the control clock signal 412 such that the turning off and turning on of the transistor switches SW1, SW2 and the transistors SW3, SW4 is synchronized in accordance with the control clock signal 412, as explained above. The synchronization circuit 1002 takes advantage of the fact that, when the clock frequency is unsynchronized with the frequency of the bucket current i_{BKT}, the body diodes of either the transistor switches SW1 and the transistor SW3 or the body diodes of the transistor switch SW2 and the transistor SW4 will turn on. Whether the body diodes of the transistor switch SW1 and the transistor SW3 is turned on or whether the body diodes of the transistor switch SW2 and the transistor SW4 is turned on depends on whether the clock frequency is running too fast or too slow in comparison to the frequency of the bucket current i_{BKT}. Either one may be the case depending on which phase (i.e., CLK, XCLK) of the control clock signal 412 turns on the control clock signal 412. For example, if the clock frequency is unsynchronized with the frequency of the transistor switch SW1 and the transistor SW3 and the transistor switch SW2 and the transistor SW4, the bucket current i_{BKT} is not a clean sinusoid wave form as the lack of synchronization creates deformations in the bucket current i_{BKT}.

In some embodiments, the synchronization circuit 1002 is configured to detect an activation of a body diode of the transistor switch SW1 and an activation of the body diode of the transistor switch SW2 and adjust a frequency of the control clock signal 412 in response to either the activation of the body diode of the transistor switch SW1 or the activation of the body diode of the transistor switch SW2. In some embodiments, the synchronization circuit 1002 is configured to increase the clock frequency of the control clock signal 412 in response to detecting the activation of the body diode of the transistor switch SW1 and decrease the clock frequency of the control clock signal 412 in response to detecting the activation of the body diode of the transistor switch SW2. In other embodiments, the synchronization circuit 1002 is configured decrease the clock frequency of the control clock signal 412 in response to detecting the activation of the body diode of the transistor switch SW1 and increase the clock frequency of the control clock signal 412 in response to detecting the activation of the body diode of the transistor switch SW2. Again, whether the detection of the activation of the body diode of the transistor switch SW1 or the activation of the body diode of the transistor switch SW2 results in the synchronization circuit 1002 increasing or decreasing the clock frequency depends on the relationship of which phase (CLK, XCLK) turns on and turns off the transistor switches SW1, SW2. The synchronization circuit 1002 is configured to adjust the clock frequency in this manner until the clock frequency and the frequency of the bucket current i_{BKT} are synchronized and, thus, the body diodes do not turn on during oscillation. In some embodiments, the synchronization circuit 1002 may detect whether the body diode of the transistor switch SW1 or the body diode of the transistor switch SW2 turns on by detecting the voltage at the intermediary node 1006, as explained below.

In some embodiments, the synchronization circuit 1002 is configured to detect an activation of a body diode of the transistor SW3 and an activation of a body diode of the transistor SW4 and adjust a frequency of the control clock signal 412 in response to either the activation of the body diode of the transistor SW3 or the activation of the body diode of the transistor SW4. In some embodiments, the synchronization circuit 1002 is configured increase the clock frequency of the control clock signal 412 in response to detecting the activation of the body diode of the transistor SW3 and decrease the clock frequency of the control clock signal 412 in response to detecting the activation of the body diode of the transistor SW4. In other embodiments, the synchronization circuit 1002 is configured decrease the clock frequency of the control clock signal 412 in response to detecting the activation of the body diode of the transistor SW3 and increase the clock frequency of the control clock signal 412 in response to detecting the activation of the body diode of the transistor SW4. Again, whether the detection of the activation of the body diode of the transistor SW3 or the activation of the body diode of the transistor SW4 results in the synchronization circuit 1002 increasing or decreasing the clock frequency depends on the relationship of which phase (CLK, XCLK) turns on and turns off the transistors SW3, SW4. The synchronization circuit 1002 is configured to adjust the clock frequency in this manner until the clock frequency and the frequency of the bucket current i_{BKT} are synchronized and, thus, the body diodes do not turn on during oscillation. In some embodiments, the synchronization circuit 1002 may detect whether the body diode of the transistor SW3 or the body diode of the transistor SW4 turns on by detecting the voltage at the intermediary node 1008, as explained below.

It should be noted that still other embodiments of the synchronization circuit 1002 may detect whether the body diode of the transistor switch SW2 or the body diode of the transistor SW3 turn on to adjust the clock frequency. Still other embodiments of the synchronization circuit 1002 may detect whether the body diode of the transistor switch SW1 or the body diode of the transistor SW4 turn on to adjust the clock frequency.

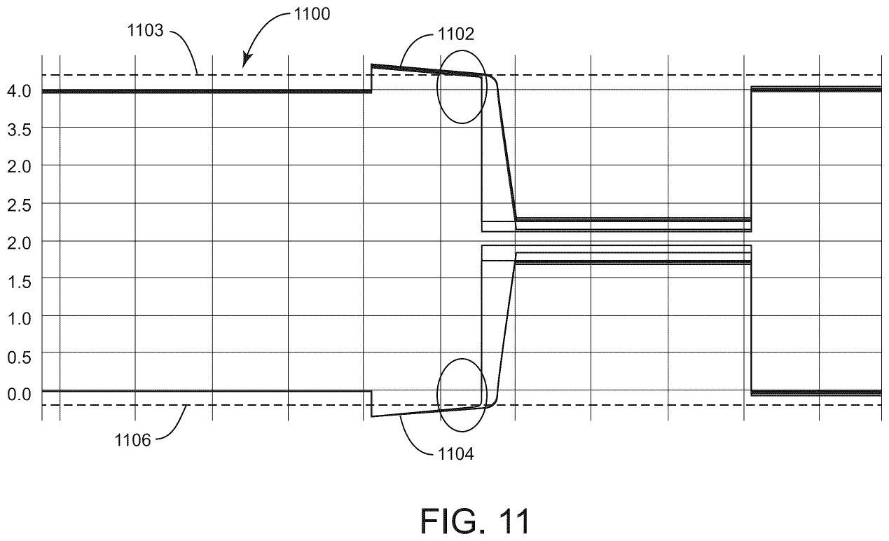

FIG. 11 shows an example of an intermediary node voltage 1100.

In some embodiments, the intermediary node voltage 1100 may be a voltage at the intermediary node 1006 in FIG. 10. When the intermediary node voltage 1100 may be a voltage at the intermediary node 1006, the synchronization circuit 1002 is configured to detect whether the body diode of the transistor switch SW1 is activated or whether the body diode of the transistor switch SW2 is activated when both the transistor switch SW1 and the transistor switch SW2 are turned off. In response to detecting that either the body diode of the transistor switch SW1 is activated or the body diode of the transistor switch SW2 is activated when both the transistor switch SW1 and the transistor switch SW2 are turned off, the synchronization circuit 1002 is configured to adjust the clock frequency of the control clock signal 412. In some embodiments, the clock frequency is increased in response to detecting that the body diode of the transistor switch SW1 has been activated when both the transistor switch SW1 and the transistor switch SW2 are turned off and the clock frequency is decreased in response to detecting that the body diode of the transistor switch SW2 has been activated when both the transistor switch SW1 and the transistor switch SW2 are turned off. In other embodiments, the clock frequency is decreased in response to detecting that the body diode of the transistor switch SW1 has been activated when both the transistor switch SW1 and the transistor switch SW2 are turned off and the clock frequency is increased in response to detecting that the body diode of the transistor switch SW2 has been activated when both the transistor switch SW1 and the transistor switch SW2 are turned off.

In some embodiments, the intermediary node voltage 1100 may be a voltage at the intermediary node 1008 in FIG. 10. When the intermediary node voltage 1100 may be a voltage at the intermediary node 1008, the synchronization circuit 1002 is configured to detect whether the body diode of the transistor SW3 is activated or whether the body diode of the transistor SW4 is activated when both the transistor SW3 and the transistor SW4 are turned off. In response to detecting that either the body diode of the transistor SW3 is activated or whether the body diode of the transistor SW4 is activated when both the transistor SW3 and the transistor SW4 are turned off, the synchronization circuit 1002 is configured to adjust the clock frequency of the control clock signal 412. In some embodiments, the clock frequency is increased in response to detecting that the body diode of the transistor SW3 has been activated when both the transistor SW3 and the transistor SW4 are turned off and the clock frequency is decreased in response to detecting that the body diode of the transistor SW4 has been activated when both the transistor SW3 and the transistor SW4 are turned off. In other embodiments, the clock frequency is decreased in response to detecting that the body diode of the transistor SW3 has been activated when both the transistor SW3 and the transistor SW4 are turned off and the clock frequency is increased in response to detecting that the body diode of the transistor SW4 has been activated when both the transistor SW3 and the transistor SW4 are turned off.

In this example, VIN is assumed to be at a direct current (DC) voltage level of 4 Volts. Additionally, ground is assumed to be at the DC voltage level of 0 Volts. In one example, if the clock frequency of the control clock signal 412 is not synchronized with the frequency of the bucket current i_{BKT}, the intermediary node voltage 1100 will increase above VIN. This is shown by a hump 1102 in the intermediary node voltage 1100. If the synchronization circuit 1002 is configured to detect the intermediary node voltage 1100 as the voltage at the intermediary node 1006, the synchronization circuit 1002 detects that the body diode of the transistor switch SW1 is activated once the intermediary node voltage 1100 is above a threshold voltage 1103. The threshold voltage 1103 has a DC threshold voltage level that is above VIN. In this embodiment, the DC threshold voltage level is 4.1 Volts. In response to the intermediary node voltage 1100 being above the threshold voltage, the synchronization circuit 1002 responds by adjusting the clock frequency. In some embodiments, the clock frequency is increased. In some embodiments, the clock frequency is decreased.

On the other hand, if the synchronization circuit 1002 is configured to detect the intermediary node voltage 1100 as the voltage at the intermediary node 1008, the synchronization circuit 1002 detects that the body diode of the transistor SW3 is activated once the intermediary node voltage 1100 is above the threshold voltage 1103. In response to the intermediary node voltage 1100 being above the threshold voltage, the synchronization circuit 1002 responds by adjusting the clock frequency. In some embodiments, the clock frequency is increased. In some embodiments, the clock frequency is decreased.

In another example, if the clock frequency of the control clock signal 412 is not synchronized with the frequency of the bucket current i_{BKT}, the intermediary node voltage will decrease below ground. This is shown by a hump 1104 in the intermediary node voltage 1100. If the synchronization circuit 1002 is configured to detect the intermediary node voltage 1100 as the voltage at the intermediary node 1006, the synchronization circuit 1002 detects that the body diode of the transistor switch SW2 is activated once the intermediary node voltage 1100 is below a threshold voltage 1106. The threshold voltage 1106 has a DC threshold voltage level that is below ground. In this embodiment, the DC threshold voltage level is −0.1 Volts. In response to the intermediary node voltage 1100 being below the threshold voltage, the synchronization circuit 1002 responds by adjusting the clock frequency. In some embodiments, the clock frequency is increased. In some embodiments, the clock frequency is decreased.

On the other hand, if the synchronization circuit 1002 is configured to detect the intermediary node voltage 1100 as the voltage at the intermediary node 1008, the synchronization circuit 1002 detects that the body diode of the transistor SW4 is activated once the intermediary node voltage 1100 is below the threshold voltage 1106. In response to the intermediary node voltage 1100 being below the threshold voltage, the synchronization circuit 1002 responds by adjusting the clock frequency. In some embodiments, the clock frequency is increased. In some embodiments, the clock frequency is decreased.

Detecting the activation of the body diodes of the transistor switches SW1, SW2 and the transistors SW3, SW4 simplifies synchronization of the clock frequency with the frequency of the bucket current i_{BKT}. This increases the conversion efficiency of the resonant charge pump circuit 1000.

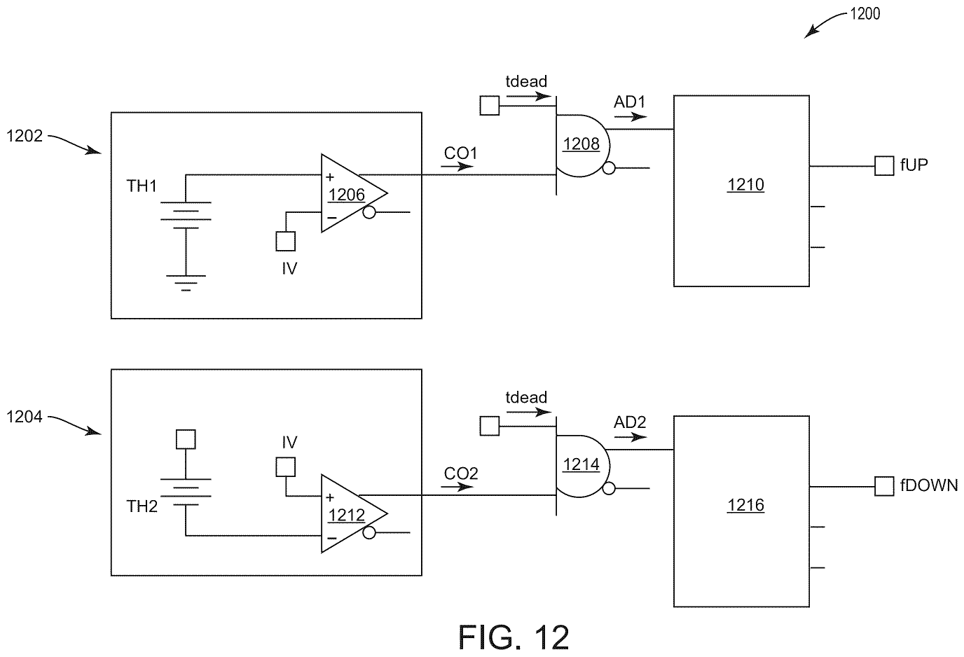

FIG. 12 shows a synchronization circuit 1200.

In some embodiments, the synchronization circuit 1002 shown in FIG. 10 is provided in the same manner as the synchronization circuit 1200 shown in FIG. 12. The synchronization circuit 1200 includes a first detection circuit 1202 and a second detection circuit 1204. The first detection circuit 1202 is configured to detect whether an intermediary node voltage IV is below a threshold voltage TH1. In some embodiments, the intermediary node voltage IV is the voltage at the intermediary node 1006 in FIG. 10. In other embodiments, the intermediary node voltage IV is the voltage at the intermediary node 1008 in FIG. 10. The threshold voltage TH1 has a DC threshold voltage level below the DC voltage level of ground. Thus, the threshold voltage TH1 corresponds with the threshold voltage 1106 in FIG. 11.

The first detection circuit 1202 includes a comparator 1206, an AND gate 1208, and a one shot 1210. In this example, the non-inverting terminal of the comparator 1206 is configured to receive the threshold voltage TH1 and the inverting terminal of the comparator 1206 is configured to receive the intermediary voltage IV. Thus, in response to the intermediary voltage IV being above the threshold voltage TH1, an output CO1 of the comparator 1206 is low. In response to the intermediary voltage IV being below the threshold voltage TH1, the output CO1 of the comparator 1206 is high. Note that the threshold voltage TH1 appears as a negative voltage since the threshold voltage TH1 is received at the non-inverting terminal while the intermediary voltage IV is received at the inverting terminal.

The AND gate 1208 is configured to receive the output CO1 and a dead time control signal tdead. The dead time control signal tdead is low when any one of the transistor switches SW1, SW2 are turned on. On the other hand, the dead time control signal tdead is high when any one of the transistor switches SW1, SW2 or the transistors SW3, SW4 are turned on. Thus, when the output CO1 is high and when the dead time control signal tdead is high, the body diode of a corresponding transistor (i.e., either the transistor switch SW2 or the transistor SW4 in FIG. 10) has been activated, which, in turn, means that the clock frequency is not synchronized with the frequency of the bucket current i_{BKT} (see FIG. 10). When either the output CO1 is low or the dead time control signal tdead is low, then an output AD1 of the AND gate 1208 is low. However, when both the output CO1 is high and the dead time control signal tdead is high, the output AD1 of the AND gate 1208 is high.

In response to the output AD1 being low, the one shot 1210 does not generate an output fUP. However, in response to the output AD1 being high, the one shot 1210 generates the output fUP. In response to the output fUP, the clock frequency of the control clock signal 412 (see FIG. 10) is increased. In other embodiments, the clock frequency of the control clock signal 412 is decreased in response to the output AD1 being high.

The second detection circuit 1204 is configured to detect whether the intermediary node voltage IV is above a threshold voltage TH2. In some embodiments, the intermediary node voltage IV is the voltage at the intermediary node 1006 in FIG. 10. In other embodiments, the intermediary node voltage IV is the voltage at the intermediary node 1008 in FIG. 10. The threshold voltage TH1 has a DC threshold voltage level above the DC voltage level of VIN. Thus, the threshold voltage TH1 corresponds with the threshold voltage 1103 in FIG. 11.

The second detection circuit 1204 includes a comparator 1212, an AND gate 1214, and a one shot 1216. In this example, the non-inverting terminal of the comparator 1206 is configured to receive the intermediary voltage IV and the inverting terminal of the comparator 1206 is configured to receive the threshold voltage TH2. Thus, in response to the intermediary voltage IV being below the threshold voltage TH2, an output CO2 of the comparator 1206 is low. In response to the intermediary voltage IV being above the threshold voltage TH2, the output CO1 of the comparator 1206 is high. The output CO2 is thus high in response to the intermediary voltage IV being above the threshold voltage TH2. Note that the threshold voltage TH2 appears positive since the intermediary voltage IV is received at the non-inverting terminal and the threshold voltage TH2 is received at the inverting terminal.

The AND gate 1214 is configured to receive the output CO2 and the dead time control signal tdead. Thus, when the output CO2 is high and when the dead time control signal tdead is high, this means that the body diode of a corresponding transistor (i.e., either the transistor switch SW1 or the transistor SW3) has been activated, which, in turn, means that the clock frequency is not synchronized with the frequency of the bucket current i_{BKT} (see FIG. 10). When either the output CO2 is low or the dead time control signal tdead is low, an output AD2 of the AND gate 1208 is low. However, when both the output CO2 is high and the dead time control signal tdead is high, the output AD2 of the AND gate 1208 is high.

In response to the output AD2 being low, the one shot 1216 does not generate an output fDOWN. However, in response to the output AD2 being high, the one shot 1216 generates the output fDOWN. In response to the output fDOWN, the clock frequency of the control clock signal 412 (see FIG. 10) is decreased. In other embodiments, the clock frequency of the control clock signal 412 is increased in response to the output AD2 being high.

Although certain specific embodiments are described above for instructional purposes, the teachings of this patent document have general applicability and are not limited to the specific embodiments described above. The function of the hardware circuitry illustrated in the figures can be implemented in hardware circuitry as shown, or in a combination of dedicated hardware circuitry and software, or largely in software. Accordingly, various modifications, adaptations, and combinations of various features of the described embodiments can be practiced without departing from the scope of the invention as set forth in the claims.

What is claimed is:

1. A resonant charge pump circuit, comprising:
a resonant circuit having a bucket capacitor and a bucket inductor connected in series;
a first transistor configured to be turned off and turned on, the first transistor being connected to enable current to flow from an input terminal into the resonant circuit to charge the bucket capacitor and the bucket inductor when the first transistor is turned on and to disable the current to flow from the input terminal into the resonant circuit when the first transistor is turned off;
a second transistor configured to be turned off and turned on, the second transistor being configured to enable the current to flow from the resonant circuit to discharge the bucket capacitor and the bucket inductor to an output terminal when the second transistor is turned on and to disable the current to flow from the resonant circuit to the output terminal when the second transistor is turned off; and
a synchronization circuit configured to generate a clock signal such that the turning off and turning on of the first transistor and the second transistor is synchronized in accordance with the clock signal, wherein the synchronization circuit is configured to detect an activation of a first body diode of the first transistor and an activation of a second body diode of the second transistor and adjust a frequency of the clock signal in response to either the activation of the first body diode or the activation of the second body diode.

2. The resonant charge pump circuit of claim 1, wherein:
the first transistor is a first field effect transistor (FET); and
the second transistor is a second FET.

3. The resonant charge pump circuit of claim 1, wherein the synchronization circuit is configured to:
increase the frequency of the clock signal in response to detecting the activation of the first body diode; and
decrease the frequency of the clock signal in response to detecting the activation of the second body diode.

4. The resonant charge pump circuit of claim 1, wherein the synchronization circuit is configured to:
decrease the frequency of the clock signal in response to detecting the activation of the first body diode; and
increase the frequency of the clock signal in response to detecting the activation of the second body diode.

5. The resonant charge pump circuit of claim 1, wherein the synchronization circuit is configured to operate the turning on and turning off of the first transistor and the second transistor in accordance with the clock signal such that:
the first transistor is turned on and the second transistor is turned off in a first state;
the second transistor is turned on and the first transistor is turned off in a second state; and
both the first transistor and the second transistor are turned off in a third state.

6. The resonant charge pump circuit of claim 5, wherein the synchronization circuit is configured to detect the activation of the first body diode of the first transistor and the activation of the second body diode of the second transistor when both the first transistor and the second transistor are turned off in the third state.

7. The resonant charge pump circuit of claim 6, wherein the synchronization circuit comprises:
a comparator that receives an intermediary voltage from an intermediary node that is between the first transistor and the second transistor, the comparator being configured to generate a detection signal in a detection state in response to the intermediary voltage being above a threshold voltage level that is above an input voltage level of an input voltage at the input terminal;
an AND gate that is configured to receive a deadtime signal that is in a deadtime state in response to the third state, the AND gate being configured to generate a frequency adjustment signal in a frequency adjustment state in response to the detection signal being in the detection state and the deadtime signal being in the deadtime state; and
a one shot configured to adjust a clock frequency in response to the frequency adjustment signal being in the frequency adjustment state.

8. The resonant charge pump circuit of claim 6, wherein the synchronization circuit comprises:
a comparator that receives an intermediary voltage from an intermediary node that is between the first transistor and the second transistor, the comparator being configured to generate a detection signal in a detection state in response to the intermediary voltage being below a threshold voltage level that is below ground;
an AND gate that is configured to receive a deadtime signal that is in a deadtime state in response to the third state, the AND gate being configured to generate a frequency adjustment signal in a frequency adjustment state in response to the detection signal being in the detection state and the deadtime signal being in the deadtime state; and
a one shot configured to adjust a clock frequency in response to the frequency adjustment signal being in the frequency adjustment state.

9. The resonant charge pump circuit of claim 1, further comprising a switching circuit connected to the resonant circuit, wherein the switching circuit is configured to:
switch to a first state that enables current to flow from the input terminal into the resonant circuit to charge the bucket capacitor and the bucket inductor;
switch to a second state that enables the current to flow from the resonant circuit to discharge the bucket capacitor and the bucket inductor to the output terminal; and
switch to a third state that disables the current from flowing from the input terminal into the resonant circuit and that disables the current to flow from the resonant circuit to discharge the bucket capacitor and the bucket inductor to the output terminal.

10. The resonant charge pump circuit of claim 9, wherein the switching circuit comprises the first transistor and the second transistor.

11. The resonant charge pump circuit of claim 9, wherein:
the first transistor connects the input terminal to the resonant circuit when the switching circuit is in the first state and disconnects the input terminal from the resonant circuit when the switching circuit is in the second state and in the third state, the first transistor being external to the switching circuit; and
the second transistor connects the resonant circuit to the output terminal when the switching circuit is in the second state and disconnects the output terminal from the resonant circuit when the switching circuit is in the first state and in the third state, the second transistor being external to the switching circuit.

12. A method for operating a resonant charge pump, the method comprising:
in a first state, turning on a first transistor to enable current to flow from an input terminal into a resonant circuit to charge a bucket capacitor and a bucket inductor and turning off a second transistor to disable current to flow from the resonant circuit to discharge the bucket capacitor and the bucket inductor to an output terminal;
in a second state, turning off the first transistor to disable the current from flowing from the input terminal into the resonant circuit to charge the bucket capacitor and turning off the second transistor to disable the current from flowing from the resonant circuit to discharge the bucket capacitor and the bucket inductor to the output terminal;
in a third state, turning off the first transistor to disable the current from flowing from the input terminal into the resonant circuit to charge the bucket capacitor and the bucket inductor and turning on the second transistor to enable the current to flow from the resonant circuit to discharge the bucket capacitor and the bucket inductor to the output terminal;
generating a clock signal such that the opening and closing of the first transistor and the second transistor is synchronized in accordance with the clock signal;
detecting that any one of either an activation of a first body diode of the first transistor is activated or an activation of a second body diode of the second transistor is in the second state; and
adjusting a frequency of the clock signal in response to either the activation of the first body diode or the activation of the second body diode.

13. The method of claim 12, wherein adjusting the frequency of the clock signal in response to either the activation of the first body diode or the activation of the second body diode comprises:
increasing the frequency of the clock signal in response to detecting the activation of the first body diode; and
decreasing the frequency of the clock signal in response to detecting the activation of the second body diode.

14. The method of claim 12, wherein adjusting the frequency of the clock signal in response to either the activation of the first body diode or the activation of the second body diode comprises:
decreasing the frequency of the clock signal in response to detecting the activation of the first body diode; and
increasing the frequency of the clock signal in response to detecting the activation of the second body diode.

15. The method of claim 12, wherein detecting that any one of either the activation of the first body diode of the first transistor is activated or the activation of the second body diode of the second transistor is in the second state comprises:
receiving an intermediary voltage from an intermediary node that is between the first transistor and the second transistor;
generating a detection signal in a detection state in response to the intermediary voltage being above a threshold voltage level that is above an input voltage level of an input voltage at the input terminal; and
receiving a deadtime signal that is in a deadtime state in response to the second state.

16. The method of claim 15, wherein adjusting the frequency of the clock signal in response to either the activation of the first body diode or the activation of the second body diode comprises:
generating a frequency adjustment signal in a frequency adjustment state in response to the detection signal being in the detection state and the deadtime signal being in the deadtime state; and
adjusting a clock frequency in response to the frequency adjustment signal being in the frequency adjustment state.

17. The method of claim 12, wherein detecting that any one of either the activation of the first body diode of the first transistor is activated or the activation of the second body diode of the second transistor is in the second state comprises:
receiving an intermediary voltage from an intermediary node that is between the first transistor and the second transistor;
generating a detection signal in a detection state in response to the intermediary voltage being below a threshold voltage level that is below ground; and
receiving a deadtime signal that is in a deadtime state in response to the second state.

18. The method of claim 17, wherein adjusting the frequency of the clock signal in response to either the activation of the first body diode or the activation of the second body diode comprises:
generating a frequency adjustment signal in a frequency adjustment state in response to the detection signal being in the detection state and the deadtime signal being in the deadtime state; and
adjusting a clock frequency in response to the frequency adjustment signal being in the frequency adjustment state.

19. A power system comprising a resonant charge pump circuit, the resonant charge pump circuit comprising:
a resonant circuit having a bucket capacitor and a bucket inductor connected in series;
a first transistor configured to be turned off and turned on, the first transistor being connected to enable current to flow from an input terminal into the resonant circuit to charge the bucket capacitor and the bucket inductor when the first transistor is turned on and to disable the current to flow from the input terminal into the resonant circuit to charge the bucket capacitor and the bucket inductor when the first transistor is turned off;
a second transistor configured to be turned off and turned on, the second transistor being configured to enable the current to flow from the resonant circuit to discharge the bucket capacitor and the bucket inductor to an output terminal when the second transistor is turned on and to disable the current to flow from the resonant circuit to discharge the bucket capacitor and the bucket inductor to the output terminal when the second transistor is turned off; and
a synchronization circuit configured to generate a clock signal such that the opening and closing of the first transistor and the second transistor is synchronized in accordance with the clock signal, wherein the synchronization circuit is configured to detect an activation of a first body diode of the first transistor and an activation of a second body diode of the second transistor and adjust a frequency of the clock signal in response to either the activation of the first body diode or the activation of the second body diode.

20. The power system of claim 19, wherein the synchronization circuit is configured to:
increase the frequency of the clock signal in response to detecting the activation of the first body diode; and
decrease the frequency of the clock signal in response to detecting the activation of the second body diode.

21. The power system of claim 19, wherein the synchronization circuit is configured to:
decrease the frequency of the clock signal in response to detecting the activation of the first body diode; and
increase the frequency of the clock signal in response to detecting the activation of the second body diode.
